(19) United States
(12) Patent Application Publication
(10) Pub. No.: US 2008/0274243 A1
(43) Pub. Date: Nov. 6, 2008

(54) BAKING PAN

(75) Inventors: Janet Fang, Brooklyn, NY (US); Carolyn K. LeFavour, Naperville, IL (US)

Correspondence Address: TROUTMAN SANDERS LLP, 600 PEACHTREE STREET , NE, ATLANTA, GA, 30308, US

(73) Assignee: Lifetime Brands, Inc., Garden City, NY (US)

(21) Appl. No.: 11/744,049

(22) Filed: May 3, 2007

(51) Int. Cl. A47J 37/01

(52) U.S. Cl. 426/389; 249/134; 249/160; 249/168

(57) ABSTRACT

A baking pan that includes a main support structure and a plurality of baking wells are disposed within the main support structure, wherein the plurality of baking wells combine to form a decorative shape. The baking pan is used to create decorative cakes.

### TECHNICAL FIELD

The present invention relates generally to a baking pan with wells, and in particular to a baking pan with wells of varying shapes and sizes that combine to form a decorative shape.

### BACKGROUND OF THE INVENTION

Food products, such as muffins and cupcakes, are common food items often created at home or made at a commercial establishment. Muffins, for example, are a popular breakfast and snack choice and can vary in flavor based on the many available recipes. Cupcakes can also be made in a variety of colors and flavors, such as vanilla, chocolate, carrot-cake, red-velvet, and other suitable flavors.

When making muffins, cupcakes, and other baking products, cooks often use pans having multiple baking wells or vessels that are adapted to hold batter ingredients during the baking process. The baking wells are used as a mold to assist in the formation of a muffin or cupcake as it is baking in an oven. Such pans typically include four, six, eight, twelve, or sixteen baking wells of uniform size and shape.

Currently, baking pans are formed in a wide variety of decorative shapes including, but not limited to, hearts, butterflies, trains, ladybugs, snowmen, pumpkins, Christmas trees, flowers, cartoon characters, or the like. Such decorative baking pans are used for making cakes in decorative shapes for special occasions. Once baked, these cakes are decorated before being sliced and consumed.

Traditional baking pans are generally made completely of sheet metal or silicone. Such pans have a top surface with more or less cylindrical baking wells that extend below the top surface. These baking wells are generally an integral part of the top surface of the pan and are either formed out of the same piece of material or are permanently attached to the top surface of the pan. The baking wells of the pan are generally of the same shape and/or size.

Silicone is a good choice for bakeware because of its high heat-resistance properties. Another advantage is that it has good release properties, which means that it requires no greasing and cleanup, either by hand or in the dishwasher, is very easy. Others have embraced silicone in bakeware and have for the most part emulated the shape of traditional metal bakeware in the silicone molds. This bakeware cooks as well as traditional bakeware, but there are several drawbacks: The cost is higher; The pans are flexible so it helps to have a stiff metal sheet underneath to help slide it into the oven; The cooking times can be a little longer; There is still a difficulty in removing the food from the forms other than the muffins (which can be pushed out individually).

The release properties and the ability to be molded into virtually limitless shapes are important consideration. Another objective is to see if the silicone baking apparatus could replace all of the traditional bakeware forms on the market as well as overcome some of the problems inherent in baking in general. Several products attempt to overcome problems in baking.

What is needed, therefore, is a pan with baking wells that allows for easy use of one or more baking wells. The baking wells are of various shapes and sizes, such that the baking wells combine to form a decorative shape. Further, what is needed is pan that includes a plurality of baking wells, such that the baking wells combine to form the decorative shape and such that the baked item does not need to be sliced to form individual servings. It is to such a device that the present invention is primarily directed.

### BRIEF SUMMARY OF THE INVENTION

Briefly described, in preferred form, the present invention is a baking pan that includes a main support structure and a plurality of baking wells that are disposed within the main support structure, wherein the plurality of baking wells combine to form a decorative shape. In exemplary embodiments, the baking pan is used to create decorative cakes that do not require slicing into individual servings once baked.

Also described herein is a method of making a partitioned decorative cake including: preparing a batter; placing the batter into a plurality of baking wells of a baking pan; baking the baking pan and batter; and removing the cooked batter from the plurality of baking wells, wherein the plurality of baking wells are disposed within a main support structure of the baking pan and combine to form a decorative shape.

A principle object of the present invention is to provide a baking pan with a plurality of baking wells, thereby allowing a user create a cake that does not need to be cut for the separation of individual servings.

Another object of the present invention is to provide a baking pan including a plurality of baking wells, which combine to form a decorative shape.

These and other objects, features and advantages of the present invention will become more apparent upon reading the following specification in conjunction with the accompanying drawings.

### BRIEF DESCRIPTION OF THE FIGURES

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A & B, collectively referred to as FIG. 1, illustrate an exemplary embodiment of a baking pan in the shape of a butterfly in accordance with the present invention;

FIG. 2 illustrates another exemplary embodiment of a baking pan in the shape of an alligator in accordance with the present invention;

FIG. 3 illustrates another exemplary embodiment of a baking pan in the shape of a snowman in accordance with the present invention;

FIG. 4 illustrates another exemplary embodiment of a baking pan in the shape of a train in accordance with the present invention;

FIG. 5 illustrates another exemplary embodiment of a baking pan in the shape of a turtle in accordance with the present invention;

FIG. 6 illustrates another exemplary embodiment of a baking pan in the shape of a car in accordance with the present invention;

FIG. 7 illustrates another exemplary embodiment of a baking pan in the shape of a Hershey's Kiss in accordance with the present invention;

FIG. 8 illustrates the steps of a process of using the baking pan of FIG. 3 to create a decorative cake in accordance with the present invention.

The detailed description explains the exemplary embodiments of the invention, together with advantages and features, by way of example with reference to the drawings.

### DETAILED DESCRIPTION OF THE PREFERRED EMBODIMENTS

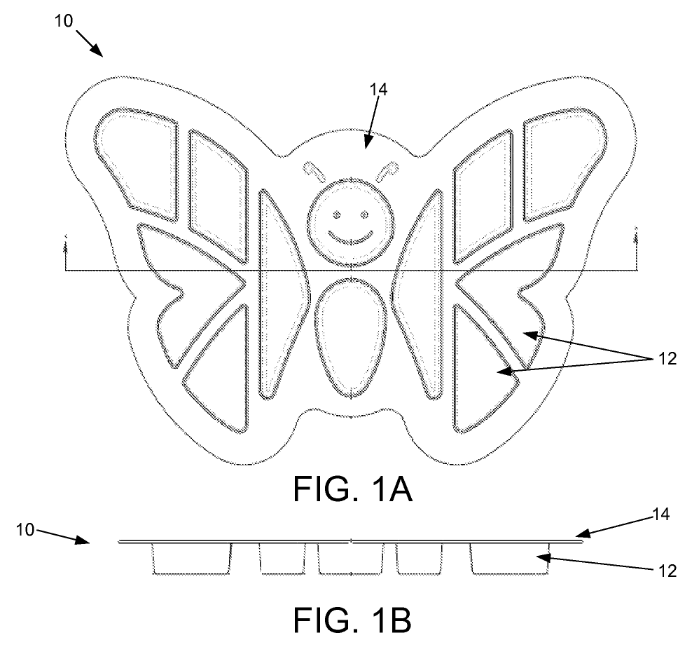

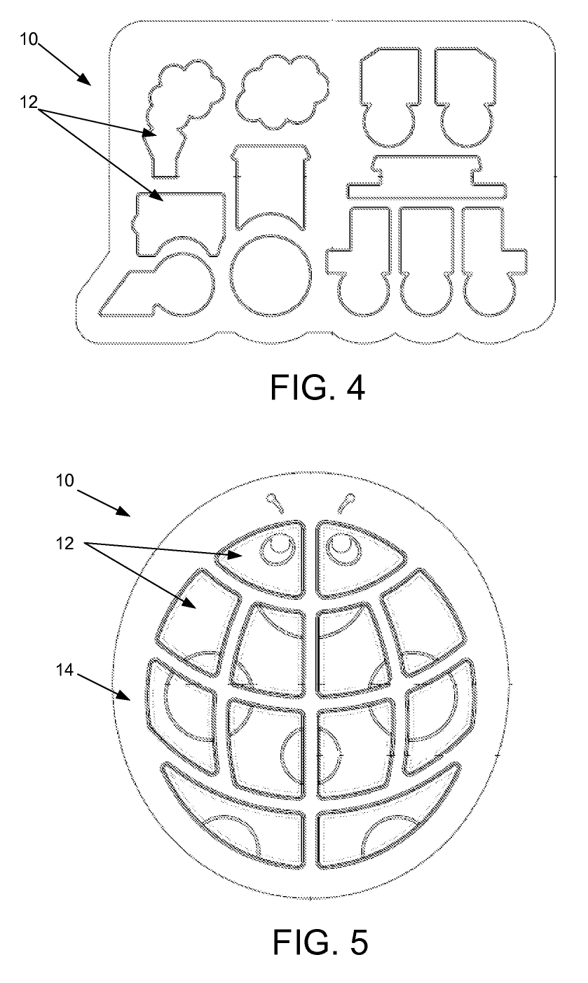

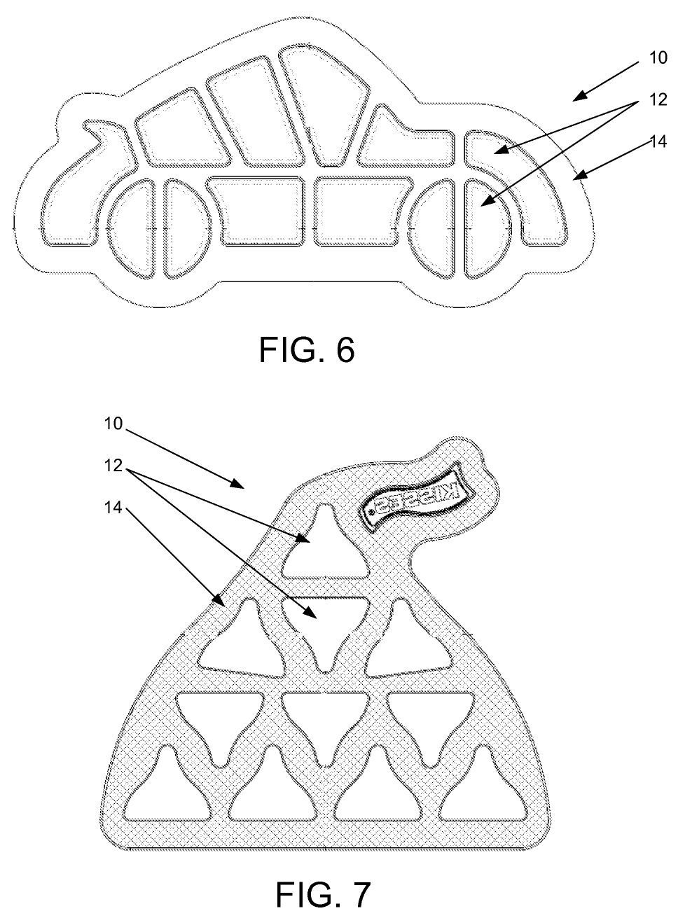

Referring now in detail to the drawing figures, wherein like reference numerals represent like parts throughout the several views, the present invention provides a baking pan 10 that includes a plurality of baking wells 12, as illustrated in FIGS. 1-7, which permits a user to bake muffins, cupcakes, and other food items in a customary and normal manner, but with additional benefits over traditional baking pans. The baking pan 10 is designed for receiving baking contents, such as batter, gelatin, or mix, within baking wells 12 (also referred to as cups, vessels, or receptacles) having a variety of available shapes and sizes, while providing a main support structure 14 for maintaining the baking wells 12 in a predetermined position during use. As shown in FIG. 1, the baking pan 10 has a generally decorative shape of a butterfly. It is contemplated that the baking pan 10 can have a wide variety of decorative shapes and the exemplary decorative shapes as shown and described herein are not intended to be limiting in anyway.

As described more fully below, each individual baking well 12 can be of a different size and/or shape. As such, many different combinations are possible utilizing any number of baking wells 12 having similar or different sizes and shapes. The baking wells 12 allow for a user to effortlessly remove a muffin or other food product from a particular baking well 12 after baking or other preparation. The baking wells 12 combine to form a decorative shape 16, such that once the food product is removed from the baking wells 12 of the baking pan 10 they can be positioned adjacent to one another to form a seemingly solid food product. While seemingly a solid food product, the food product produced by the baking pan 10 actually produces a plurality of smaller serving sizes.

The baking pan 10 of the present invention can be utilized for many items such as muffins, cakes, cupcakes, rolls, gelatins, juices, doughnuts, bagels, and other baked and non-baked items. Although the description may refer generically to the present invention as a cake pan, it should be understood that the features of the baking pan 10 can be utilized for other bakery items while remaining within the scope of the present invention.

As shown in FIGS. 1-7, the baking pan 10 comprises a main support structure 14 defining a plurality of baking wells 12, which combine to form a variety of decorative shapes 16. The main support structure 14 is adapted to adequately support the baking wells 12 during use and to maintain the spatial relationship of the baking wells 12. In an exemplary embodiment, the baking pan 10 is a silicone baking mold that creates individual cake forms, and when arranged in the formation implied by the baking pan 10, come together to create one unitary cake that does not require cutting (through the use of a knife or other cake serving utensil) for serving. Each baking pan 10 has several baking wells 12 and the individual cake forms are created through the use of one baking pan 10 to create one unitary cake.

In exemplary embodiments, the baking pan 10, including the baking wells 12 and the support structure 14 are constructed of silicone. However, it is also contemplated that the baking pan 10 may be constructed of a material other than silicone. More specifically, a baking pan 10 constructed of any standard bakeware material (e.g. metal or ceramic) would produce the same results. Different gauges and or finishes of silicone, metal, and/or other materials used to create the baking pan 10 may be used to create similar results.

The baking pan 10, including the main support structure 14 and associated baking wells 12, are made from a material that can withstand oven temperatures during baking. Such temperatures generally include a range from about 100° F. to about 450° F. (or about 38° C. to about 232° C.). Higher or lower temperatures may be used depending on the ingredients used in baking. Further, baking pan 10, including the main support structure 14 and associated baking wells 12, can be made of a material that can also withstand cold temperatures when, for example, the present invention is placed in a refrigerator or freezer. Accordingly, the material can also withstand temperatures ranging from about −10° F. to about 60° F. (or about −23° C. to about 14° C.).

In accordance with exemplary embodiments of the invention, a user may use the baking pan 10 to create a cake that has a decorative shape 16. For example, after preparing a baking batter, a user fills each of the baking wells 12 in the baking pan 10 with the batter and bakes the batter. Once the batter has been baked, the user removes each section of cake, or cupcake, from its baking well 12 and arranges it in the same order/relative position in which it was removed. The cupcakes singularly may or may not be arbitrary shapes (i.e. they may or may not appear to be a specific shape relating to the intended final cake shape). However, when combined and arranged in the suggested formation of the baking pan 10, the cupcakes form a single decorative shape in the shape implied by the baking pan 10, which can then be frosted or otherwise decorated.

In exemplary embodiments, the baking wells 12 may be of different shapes and sizes; the number of baking wells 12 may vary. Additionally, the total combined capacity of the baking wells 12 may include various ranges depending on the decorative shape of the baking pan 10. In addition to being used for preparing baked goods, alternative uses of the baking pan 10 may include the use of any food products that could be used for mold purposes. For example, the baking pan 10 could be used as a mold for gelatin, or other suitable applications.

One skilled in the art will recognize that the baking wells 12 of the present invention can be used with any product material requiring a mold structure. Accordingly, the baking pan 10 and baking wells 12 of the present invention can be used for foods such as cakes, muffins, cookies, brownies, gelatin, popsicles, and other food products that require a mold structure. Further, the baking pan 10 and baking wells 12 can be used for non-food products such as candle or soap making. As such, the baking pan 10 and baking wells 12 can be used in a manner that requires no baking whatsoever.

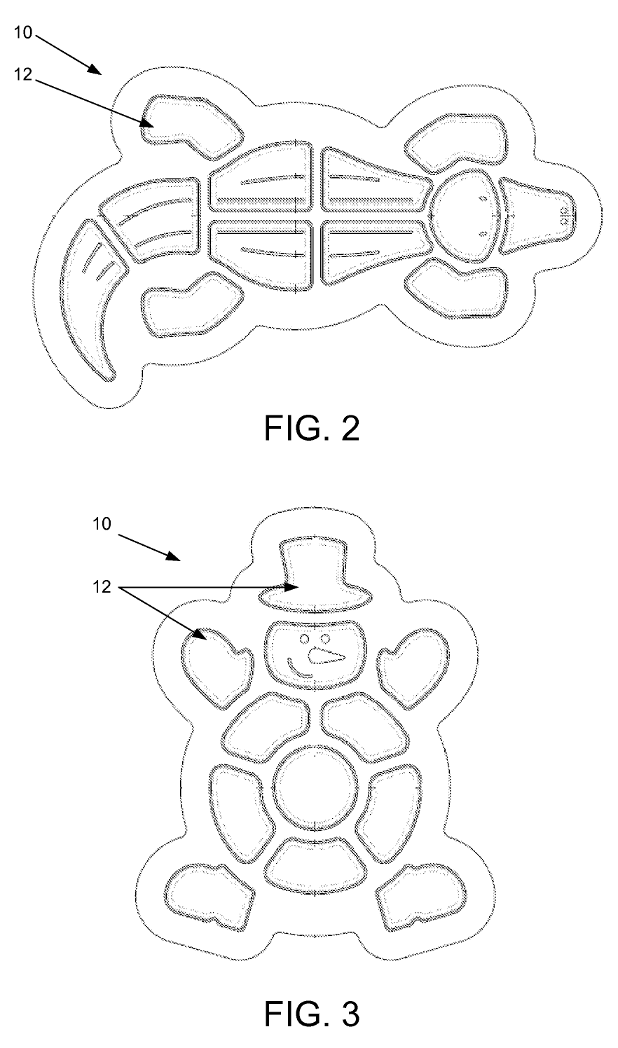

FIGS. 1A & B, illustrate an exemplary embodiment of a baking pan in the shape of a butterfly in accordance with the present invention. FIG. 1A is a top view of the baking pan 10 and FIG. 1B is a side view of the baking pan 10, which illustrate the configuration of the baking wells 12. As mentioned above, the decorative shape of the baking pan can take on a wide variety of shapes. FIGS. 2-7 illustrate various exemplary embodiments of the present invention in which the decorative shape of the baking pans are an alligator, a snowman, a train, a ladybug, a car, and a Hershey's Kiss, respectively. Each of the baking pans 10 illustrated in FIGS. 2-7 include a plurality of baking wells 12 and a support structure 14. As mentioned above, the decorative shapes illustrated in FIGS. 1-7 are intend solely for exemplary purposes and are not intended to be limiting in anyway. Rather, various additional decorative shapes are contemplated. Additionally, as illustrated in FIG. 1 one or more of the plurality of baking wells 12 may include decorative recesses or projections designed to give the surface of the baked good a decorative texture. For example, in FIG. 1, the eyes and smile of the butterfly face may be made by decorative recess or projections in the bottom of the baking well 12.

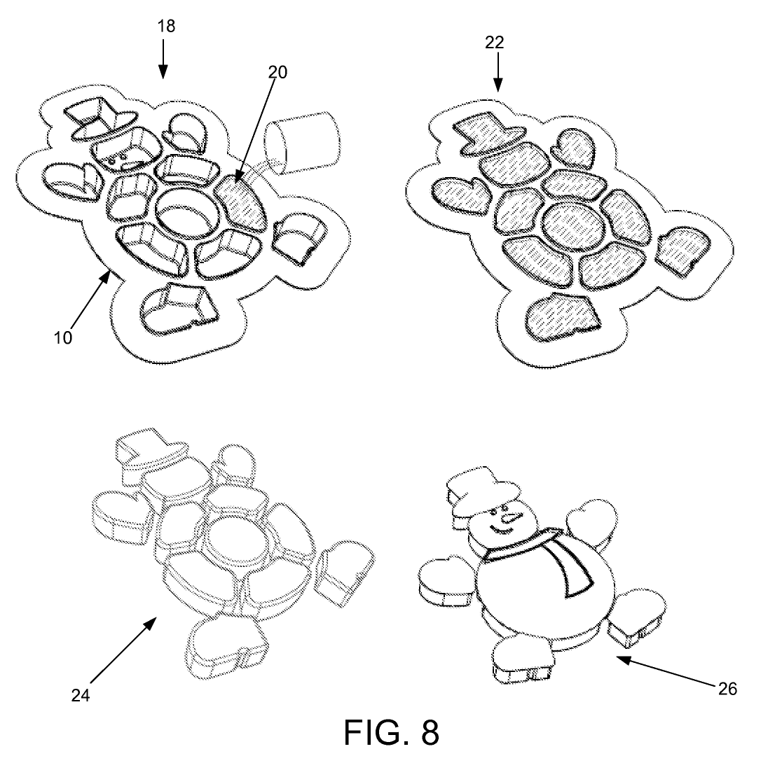

Referring to FIG. 8, a method is illustrated for preparing a decorative cake with the baking pan 10 illustrated in FIG. 3. First, as shown at 18, a user fills the baking wells 12 with a batter 20. Once all of the baking wells 12 have been filled, as shown at 22, the baking pan 10 is baked. After baking, the food products are removed from the baking wells 12 and are arranged in a manner suggested by the baking pan 10, as shown at 24. Finally, as shown at 26, the food products removed form the baking wells are placed adjacent one another and may be decorated.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A baking pan comprising:
a main support structure;
a plurality of baking wells are disposed within the main support structure, wherein the plurality of baking wells combine to form a decorative shape.

2. The baking pan of claim 1, wherein the plurality of baking wells are sized to be approximately one serving size.

3. The baking pan of claim 2, wherein the baking pan is constructed of silicone.

4. The baking pan of claim 1, wherein the plurality of baking wells each comprise a unique shape.

5. The baking pan of claim 1, wherein the baking pan is operable for making a decorative cake which does not require cutting into individual serving slices.

6. The baking pan of claim 1, wherein the main support structure maintains the special relationship of the plurality of baking wells.

7. A method of making a partitioned decorative cake comprising;
preparing a batter;
placing the batter into a plurality of baking wells of a baking pan;
baking the baking pan and batter; and
removing the cooked batter from the plurality of baking wells, wherein the plurality of baking wells are disposed within a main support structure of the baking pan and combine to form a decorative shape.

8. The method of claim 7, wherein the main support structure maintains the special relationship of the plurality of baking wells.

9. The method of claim 7, wherein the pluralities of baking wells are sized to be approximately one serving size each.

10. The method of claim 9, wherein the baking pan is constructed of silicone.

11. The method of claim 7, wherein the plurality of baking wells each comprise a unique shape.

12. The method of claim 7, wherein the baking pan is operable for making a decorative cake which does not require cutting into individual serving slices.
